(19) United States
(12) Patent Application Publication
(10) Pub. No.: US 2016/0374514 A1
(43) Pub. Date: Dec. 29, 2016

(54) SOYBEAN MILK MACHINE OF RAPID PULPING

(71) Applicant: JOYOUNG COMPANY LIMITED, Shandong (CN)

(72) Inventors: Xuning Wang, Shandong (CN); Shenghua Wang, Shandong (CN); Zongyin Liu, Shandong (CN); Weisheng Zhou, Shandong (CN)

(73) Assignee: JOYOUNG COMPANY LIMITED, Shandong (CN)

(21) Appl. No.: 15/259,814

(22) Filed: Sep. 8, 2016

Related U.S. Application Data
(63) Continuation of application No. 13/702,543, filed on Dec. 6, 2012.

(30) Foreign Application Priority Data
Jun. 9, 2010 (CN) 201010195075.1
Jun. 9, 2010 (CN) 201020219055.9
Sep. 27, 2010 (CN) 201020543739.4

(51) Int. Cl. A47J 43/07; A23L 11/00; A23C 11/10; A47J 43/044

(52) U.S. Cl. CPC A47J 43/0711; A47J 43/044; A23L 11/07; A23C 11/103; A23V 2002/00

(57) ABSTRACT

A self-cooked soybean milk machine comprises a base, a control unit, a grinding cooked device, grinding blades inside the grinding cooked device, a motor driving the grinding blades to rotate, and a preheat device. The motor and/or the grinding cooked device are/is installed on the base, with the motor electrically connected with the control unit. When the soybean material and water are blended in the grinding cooked device and is grinded into seriflux/paste, the seriflux/paste is heated and cooked by heat produced by the friction between the seriflux/paste, the grinding blades and the grinding cooked device. The design of the grinding cooked device with a high grinding and cooking efficiency allows the self-cooked soybean milk machine to reduce the pulping time and to produce the pulp in five minutes.

This application is a continuation of U.S. patent application Ser. No. 13/702,543, filed on Dec. 6, 2012, which is a U.S. national phase of PCT/CN2011/075506 titled “SOYBEAN MILK MACHINE OF RAPID PULPING, filed on Jun. 9, 2011, which claims the benefits of priorities to Chinese Patent Application No. 201010195075.1 titled “RAPID SOYBEAN MILK MAKING SOYBEAN MILK MAKER”, filed with the Chinese State Intellectual Property Office on Jun. 9, 2010; Chinese Patent Application No. 201020219055.9 titled “SELF-COOKED SOYBEAN MILK MAKER”, filed with the Chinese State Intellectual Property Office on Jun. 9, 2010; and Chinese Patent Application No. 201020543739.4 titled “SELF-HEATED SOYBEAN MILK MAKER”, filed with the Chinese State Intellectual Property Office on Sep. 27, 2010, the entire disclosures of which are incorporated herein by reference.

### FIELD OF THE INVENTION

The present application relates to a food processor, in particular, to a soybean milk maker.

### BACKGROUND OF THE INVENTION

The prior household soybean milk maker is divided into three types according to the working principle on bean crushing and soybean milk making thereof.

The first type of soybean milk maker is mounted, in the cup body thereof, with a mesh cover. Beans are placed in the mesh cover and are crushed by a cutter projected in the mesh cover. Then soybean milk made therefrom flows into the cup body through holes of the mesh cover.

In the second type of soybean milk maker, the mesh cover is removed. Beans are placed in the cup body, and are crushed and made into soybean milk through high-speed rotating of the cutter. This type of soybean milk maker may be further provided, on an inner wall of the cup body, with a baffle to facilitate the crushing of the beans. With the baffle, the space in the cup body becomes irregular, and by changing circulation direction of the fluid, the material flowing to the wall of the cup under a radial force of the blade flows back to the proximity of blade to be crushed.

In the third type of soybean milk maker, the mesh cover is replaced by a flow guiding member. Where performing the crushing, the material is placed in the cup body and is circulated inside and outside the flow guiding member under the pumping action of the crushing cutter to be crushed and made into soybean milk.

However, to make soybean milk, a large space is needed in each of the above three types of soybean milk makers such that the material can be repeatedly circulated to the proximity of the crushing cutter to be crushed, thereby the circulation path of the material is long, which inevitably reduces the times that the material is in collision with the crushing cutter per unit of time, thereby reducing the crushing efficiency. It is found that the soybean milk making cycle of the prior household soybean milk maker generally lasts for about 25 minutes, some even last for at least 30 minutes. Thus the soybean milk making speed is too slow to be adapted to the rapid pace of modern life. Moreover, in the prior household soybean milk maker, a boiling process is generally performed such that the soybean milk is cooked, which further increases the time for making soybean milk since the time for the boiling of the soybean milk is long.

### SUMMARY OF THE INVENTION

In view of this, it is necessary to provide a soybean milk maker with high crushing efficiency to realize a rapid soybean milk making.

It is provided according to the present application the following technical solutions to realize the above object.

A rapid soybean milk making soybean milk maker includes a base and a control unit. The rapid soybean milk making soybean milk maker further includes a crushing cutter, a motor driving the crushing cutter to rotate and a crushing and cooking device. The motor and the crushing and cooking device are disposed on the base, the motor is electrically connected to the control unit, and the crushing cutter is located in the crushing and cooking device. While a material is mingled with water in the crushing and cooking device and is crushed by the crushing cutter into seriflux or paste, the seriflux or paste is heated and cooked by heat generated by frictions among the seriflux or paste, the crushing cutter and the crushing and cooking device.

The crushing and cooking device has a volume of 50-1000 milliliters.

The crushing and cooking device has a volume of 100-500 milliliters.

The crushing and cooking device is a closed container or a substantially closed container.

The soybean milk maker further includes a heating unit electrically connected to the control unit.

A diameter of a sphere having a volume equal to that of the crushing and cooking device is D, a diameter of a rotation plane of the crushing cutter is d, a ratio of D to d is α, and 1<α≦3.

The crushing and cooking device is a hollow sphere, a hollow cylinder or a hollow ellipsoid.

The crushing and cooking device is provided with a feeding inlet and a discharging outlet.

A ratio of a volume of the material and the water after being mingled to a volume of the crushing and cooking device is 1:2 to 1:1.

The heating unit is disposed on the crushing and cooking device.

The heating unit is disposed upstream the crushing and cooking device.

The soybean milk maker further includes a water tank communicated with the crushing and cooking device, the heating unit is disposed on the water tank or on a water feeding passage communicating the water tank with the crushing and cooking device; or the soybean milk maker is further provided with an automatic feeding unit, the crushing and cooking device is provided with a feeding inlet, the automatic feeding unit is communicated with the feeding inlet of the crushing and cooking device, and the heating unit is provided on the automatic feeding unit.

The heating unit is disposed downstream the crushing and cooking device.

The soybean milk maker further includes a receiving device on which the heating unit is disposed; or the soybean milk maker further includes a receiving device and a discharging passage corresponding to the receiving device, the crushing and cooking device is provided with a discharging outlet, the discharging passage is communicated with the discharging outlet of the crushing and cooking device, and the heating unit is provided on the discharging passage.

The crushing and cooking device is further provided with an opening on which a cover body is removably provided.

The motor is horizontally provided in the base and is located at a side of the crushing and cooking device, and a shaft of the motor passes through the side wall of the crushing and cooking device and extends into the crushing and cooking device; or the motor is provided in the base and is located above the crushing and cooking device, the motor drives the crushing cutter to rotate through a driving shaft which passes through a hole in a top wall of the crushing and cooking device and extends downwards into the crushing and cooking device; or the motor is provided in the base and is located below the crushing and cooking device, the motor drives the crushing cutter to rotate through a driving shaft which passes through a hole in a bottom wall of the crushing and cooking device and extends upwards into the crushing and cooking device.

In the present application, the crushing and cooking device is different from the open type large volume cup body of the existing soybean milk maker, particularly the small-space container having a volume of 50-1000 milliliters. The material and water are circulated in the space of the same container, the crushing cutter is larger relative to the effective work space of the container, the crushing cutter can be protruded into the material during the crushing, the material and water are restricted, by the crushing and cooking device, around the crushing cutter to be crushed, and the crushing and circulating path of the material is short, these are all within the scope of the crushing and cooking device of the present application. It should be noted that, the volume referred to herein should be interpreted as the volume of the effective work space of the crushing and cooking device. For example, for a hollow body having a “gourd” shape, the lower portion of the hollow body is the effective work space of the hollow body, as long as the volume of the lower portion is within the scope, it also falls within the protection scope of the present application.

Term “substantially closed” mentioned in the present application means that the crushing and cooking device may also be in the following non-closed state. For example, a passage communicated with the crushing and cooking device is provided on the crushing and cooking device, and the passage is provided thereon with a hole or a slit; or the passage is sufficient long and is completely opened. As long as the structure is configured to be not only being unclosed but also being able to restrict the material and water therein for crushing such that the seriflux will not be spilled during the crushing process, the configuration is within the scope of the “substantially closed” according to the present application, and fall within the protection scope of the present application.

Advantageous effects of the present application include the following.

In the present application, the crushing and cooking device is different from the open-type large volume cup body of the existing soybean milk maker, the crushing and cooking device mentioned herein refers to the closed or substantially closed small-space container, particularly small-space container having a volume of 50-1000 milliliters. Since the crushing and cooking device has a small space and is closed or substantially closed, the probability that the material in the crushing and cooking device is crushed is increased, which not only increases the crushing efficiency, but also can make the crushing and cooking device be applicable to a higher ratio of the weight of the material to that of the water (for example, the ratio may be 2:1, which ratio can not be realized by the cup body of the existing soybean milk maker). Therefore, the soybean milk maker according to the present application can make food having a higher concentration, for example, mud-like or paste-like food. Meanwhile, the material and water in the crushing and cooking device occupies a large percent of the volume of the crushing and cooking device (compared with the material and water added in the cup body of the existing soybean milk maker, for example, the percent may be more than ½), thus more energy is provided for the crushing and colliding during the crushing process, thereby the temperature of soybean milk or soybean mud or soybean paste can be increased rapidly, which facilitates self-cooked of the soybean milk. At the same time, since heat is not easily to be dissipated, the soybean milk or soybean mud or soybean paste is continuously heated with the proceeding of the crushing, thereby is heated to a self-cooked temperature.

The crushing and cooking device according to the present application is different from cup body of the soybean milk maker available in the market. The volume of the cup body of the soybean milk maker available in the market is generally large relative to the crushing cutter, therefore the material can not be well defined in the proximity of the crushing cutter, and it requires another structure such as a mesh cover, a flow guiding device or a baffle to help to increase the crushing effect. The crushing and cooking device of the present application is disposed adjacent to the crushing cutter to define the material in the proximity of the crushing cutter, to thereby form a drastic turbulence crushing effect and improve the crushing efficiency and the cooking efficiency. Since the cup body of the soybean milk maker available in the market has a large volume, the soybean milk maker can only be used to make low-concentration soybean milk having a good fluidity.

In the present application, the crushing and cooking device is designed to have a volume of 50-1000 milliliters, which not only can ensure the normal demand for soybean milk but also can make soybean milk complying with the food safety requirements as soon as possible. In the present application, generally, high concentration soybean milk is made in the crushing and cooking device, and then is blended with water into soybean milk having a desired concentration. If the volume of the crushing and cooking device is smaller than 50 milliliters, soybean milk made therefrom is insufficient for a single person. If the volume of the crushing and cooking device is larger than 1000 milliliters, heat is dissipated too rapidly, it is difficult to provide a crushing cutter and a motor matching with the crushing and cooking device, and the time for the crushing and the cooking is long, which therefore is uneconomical.

In the present application, a uniquely designed crushing and cooking device is employed. The dimension of the crushing and cooking device is small relative to the crushing cutter, the material is defined, by the crushing and cooking device, in the proximity of the crushing cutter where being crushed, and the peripheral wall of the crushing and cooking device is adjacent to the crushing cutter such that the material is always in an ideal cut state. To see from a macroscopic perspective, the crushing and cooking device is filled with the material during the crushing, and a drastic turbulence crushing and cooking effect is formed in the proximity of the crushing cutter. Besides, since the crushing and cooking device is a closed or substantially closed container, heat generated by frictions among the seriflux/paste, the crushing cutter and the crushing and cooking device can be highly gathered within a short time such that temperature in the crushing and cooking device can be rapidly increased, thereby the seriflux/paste can be heated and cooked. That is, the soybean milk maker of the present application is different from the existing soybean milk maker in that, it does not require a heating device to boil soybean milk, but can realize “self-heated” based on the motor and the crushing and cooking device. In this way, time separately spent for boiling soybean milk after the material is crushed in the existing soybean milk maker is eliminated by the present soybean milk maker, which greatly reduces the overall time for making the soybean milk, and the soybean milk can be made within five minutes, which further makes it possible for a ready-to-drink type soybean milk maker. Where water is injected into the crushing and cooking device, the crushing cutter stirs the water such that the peripheral wall of the crushing and cooking device is automatically washed. During the crushing, only a small quantity of water and beans are blended and crushed in the present soybean milk maker, in this way, the crushing cutter only stirs and crushes the “minimum” material, which not only saves energy but also increases bean content in per unit volume, thereby the crushing efficiency and crushing thinness of the material are improved. Moreover, the concentration and the volume of soybean milk finally made by the soybean milk maker can be adjusted by controlling the amount of water or other liquid blended with the soybean milk, which can meet individual needs of consumers.

It is preferable that the crushing and cooking device is configured to have a volume of 100-500 milliliters. In this way, soybean milk after being blended with water can meet the demand of a single person and can also meet the demand of a three-person family, thereby having a good applicability.

Since the crushing and cooking device is a closed container or a substantially closed container, it can prevent heat from dissipating, thus heat generated by frictions among the seriflux/paste, the crushing cutter and the crushing and cooking device can be highly gathered within a short time, thereby temperature in the crushing and cooking device can be increased rapidly, and thus the seriflux/paste can be heated and cooked.

Water and/or material can also be heated by a heating unit of the soybean milk maker before being crushed and cooked or during the crushing and cooking process, such that a high temperature, for example, at least 900, is maintained in the crushing and cooking device, which can assist the cooking, therefore the time for the making of the soybean milk is further reduced.

The ratio of the diameter of the rotation plane of the crushing cutter to the diameter of the sphere having a volume equal to that of the crushing and cooking device is defined to be 1:3 to 1:1, which not only can ensure a smooth circulation of the material but also can define the material more efficiently such that the material is in the proximity of the crushing cutter, to thereby enhance the crushing effect of the crushing cutter.

The crushing and cooking device may be a hollow sphere, a hollow cylinder or a hollow ellipsoid.

The heating unit may be disposed on the crushing and cooking device, or be disposed upstream or downstream the crushing and cooking device. For example, the heating unit is disposed on the water tank or on a water feeding passage communicating the water tank with the crushing and cooking device; or the soybean milk maker is further provided with an automatic feeding unit, the crushing and cooking device is provided with a feeding inlet, the automatic feeding unit is communicated with the feeding inlet of the crushing and cooking device, and the heating unit is disposed on the automatic feeding unit; or the soybean milk maker further includes a receiving device and a discharging passage corresponding to the receiving device, the crushing and cooking device is provided with a discharging outlet, the discharging passage is communicated with the discharging outlet of the crushing and cooking device, and the heating unit is disposed on the discharging passage.

The soybean milk maker of the present application employs a crushing and cooking device that can be opened and closed, therefore the user can open the cover body of the crushing and cooking device to add material into the crushing and cooking device where using the soybean milk maker, in this way, the feeding mechanism and/or the water feeding mechanism may be eliminated from soybean milk maker, therefore the structure of the soybean milk maker is more compact and it is applicable to be used in household, besides the cost of the whole maker is also reduced. Moreover, to clean the crushing and cooking device, an automatic cleaning can be performed by scaling and closing the cover body and the crushing and cooking device, and a manual cleaning can also be performed by the user after the cover body is opened, therefore, many choices are provided in use and it is more convenient. Moreover, the crushing and cooking device has a certain volume, where being added with the material manually, the problem of bad crushing and cooking due to adding too much material can be effectively avoided, which has a “Fool-Proof” effect and can ensure the quality of soybean milk. Further, the user can also open the cover body anytime anywhere to replace the crushing cutter according to various materials to be crushed and cooked.

The motor of the soybean milk maker is horizontally provided on the base and is located at a side of the crushing and cooking device, the center of gravity of the whole soybean milk maker is lowered, the stability of the whole maker is improved, and the probability that the seriflux or water enters the motor and the control unit during a manual operation is reduced, thus the making of the soybean milk is more safe and reliable. Further, the crushing cutter is brought into direct contact with the material and is driven by the motor to rotate at a high speed to thereby crush the material. Thereby the crushing efficiency is improved.

The motor of the soybean milk maker of the present application is extended in the crushing and cooking device from the bottom portion of the crushing and cooking device such that the cutter shaft or the shaft of the motor is always in the seriflux during the making of the soybean milk, that is, the shaft of the motor is washed by the seriflux continuously. In this way, most of the heat generated by the friction between the shaft of the motor shaft or the cutter shaft rotated at a high speed and the bearing will be directly transferred to the seriflux, which, on the one hand, can reduce the temperature of the shaft of the motor or the cutter shaft to prevent the soybean milk from being burned due to the overheat of the shaft of the motor or the cutter shaft, meanwhile the shaft of the motor or the cutter shaft is cleaned by the washing of the seriflux, and thus the problem that the shaft of the motor or the cutter shaft is stuck and can not be cleaned up is solved; on the other hand, it also facilitates the cooking of the soybean milk, thereby the time for making the soybean milk is further reduced. Further, since the soybean milk maker is provided with a base, the center of gravity of the whole soybean milk maker is lowered and the stability of the whole maker is improved. Still further, since the crushing cutter is in direct contact with the material and is driven by the motor to rotate at a high speed to crush the material, the crushing efficiency is improved.

### BRIEF DESCRIPTION OF THE DRAWINGS

The present application is further illustrated in detail hereinafter in conjunction with the accompanying drawings.

FIG. 1 is a perspective assembly view of a soybean milk maker according to a first preferred embodiment of the present application;

FIG. 2 is a perspective assembly view of the soybean milk maker shown in FIG. 1 viewed from another angle of view;

FIG. 3 is an exploded perspective view of the feeding mechanism and other components shown in FIG. 1;

FIG. 4 is a schematic view showing a feeding mechanism, a crushing and cooking device and other components of a soybean milk maker according to a second preferred embodiment of the present application;

FIG. 5 is a schematic view showing a crushing and cooking device of a soybean milk maker according to a third preferred embodiment of the present application;

FIG. 6 is a schematic view showing a soybean milk maker according to a fourth preferred embodiment of the present application;

FIG. 7 is a schematic view showing a soybean milk maker according to a fifth preferred embodiment of the present application;

FIG. 8 is a schematic view showing a crushing and cooking device of a soybean milk maker according to a sixth preferred embodiment of the present application;

FIG. 9 is a schematic view showing a crushing and cooking device of a soybean milk maker according to a seventh preferred embodiment of the present application;

FIG. 10 is a schematic view showing a crushing and cooking device of a soybean milk maker according to an eighth preferred embodiment of the present application;

FIG. 11 is a schematic view showing a crushing and cooking device of a soybean milk maker according to a ninth preferred embodiment of the present application;

FIG. 12 is an enlarged view of the mounting structure of the crushing and cooking device shown in part II in FIG. 11;

FIG. 13 is a schematic view of a crushing and cooking device of a soybean milk maker according to a tenth preferred embodiment of the present application;

FIG. 14 is a schematic view of a crushing and cooking device of a soybean milk maker according to an eleventh preferred embodiment of the present application; and

FIG. 15 is an enlarged view of the mounting structure of the crushing and cooking device shown in part II in FIG. 14.

### DETAILED DESCRIPTION

The present application is further described in detail hereinafter in conjunction with the figures and the embodiments.

The soybean milk maker according to the present application is applicable to make seriflux or paste-like food, for example, soybean milk and rice paste. The material mentioned herein refers to raw material before crushed such as beans or rice.

### First Embodiment

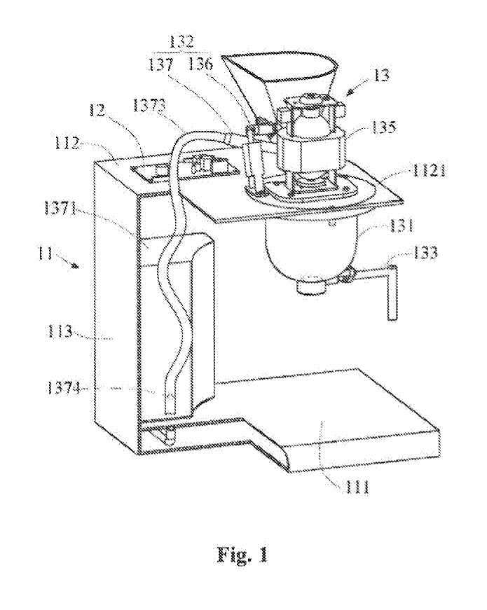

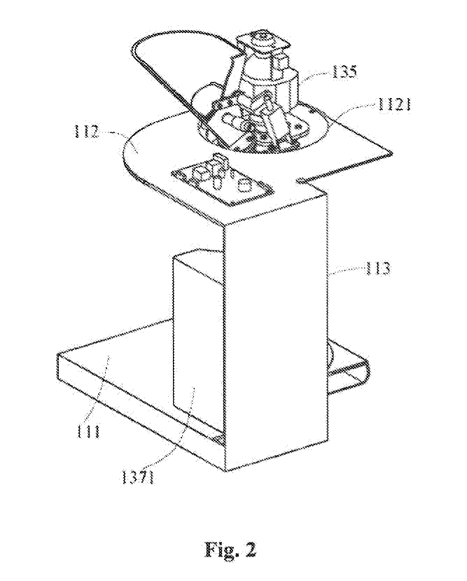

Referring to the soybean milk maker according to a first preferred embodiment of the present application shown in FIGS. 1 to 3. The soybean milk maker 10 includes a base 11, a control unit 12, a crushing and cooking device 131, a feeding mechanism 132, a discharging mechanism 133, a crushing cutter 134 and a motor 135 for driving the crushing cutter 134 to rotate. The feeding mechanism 132 and the discharging mechanism 133 are communicated with the crushing and cooking device 131, respectively. The crushing cutter 134 is located in the crushing and cooking device 131. The crushing cutter 134 stirs the material and water in the crushing and cooking device 131 such that the material is crushed and cooked into soybean milk. The motor 135 or the crushing and cooking device 131 is mounted on the base 11.

The base 11 is substantially of a “U” shape, and includes a pedestal 111, a top plate 112 arranged opposite to the pedestal 111 and a supporting arm 113 connecting the top plate 112 and the pedestal 111. The top plate 112 is provided with a through hole 1121 such that the motor 135, the feeding mechanism 132 and the like are exposed outside the through hole 1121.

The crushing and cooking device 131 is a closed container or a substantially closed container provided around the crushing cutter 134 in a three-dimensional space. The peripheral wall of the crushing and cooking device 131 is arranged adjacent to the crushing cutter 134 in the three-dimensional space. In the present embodiment, the crushing and cooking device 131 is substantially a hollow sphere, the inner surface of the peripheral wall of which is configured to be a streamline shape arc surface. Since the crushing and cooking device 131 is closed or is substantially closed, noise transmitted to the external of the crushing and cooking device 131 is greatly reduced during the operating process of the crushing cutter 134 in the crushing and cooking device, which thereby can reduce the noise. Moreover, the closed or substantially closed structure can also enhance circulating pressure of the material and water in the crushing and cooking device 131, which thereby facilitates the crushing of the material. A mounting portion 1311 is provided on the peripheral wall of the crushing and cooking device 131, the mounting portion 1311 is provided with a through hole, through which a shaft of the motor 135 is protruded into the crushing and cooking device 131, and the motor 135 is fixedly connected to the mounting portion 1311 via bolts in a vertical manner. In the present embodiment, the inner surface of the crushing and cooking device 131 is coated with a non-stick material such that it is not easy for the soybean milk to adhere to the inner surface. In the present application, the crushing and cooking device is configured to have a volume of 50-1000 milliliters, which not only ensures a normal soybean milk requirement but also can cook the soybean milk as soon as possible such that the cooked soybean milk complies with the requirements of the food safety. The soybean milk maker according to the present application can finish the making of soybean milk within five minutes. If the volume of the crushing and cooking device is smaller than 50 milliliters, soybean milk made by the soybean milk maker is insufficient for a single person, thereby the utility of the soybean milk maker is low; if the volume of the crushing and cooking device is larger than 1000 milliliters, heat is dissipated too rapidly during the crushing and cooking process, it is difficult to provide a crushing cutter and a motor matching with the crushing and cooking device, and the time for the crushing and the cooking is long, which therefore is uneconomical.

In the present embodiment, the volume of the crushing and cooking device is 300 milliliters.

The feeding mechanism 132 includes a bean feeding assembly 136 for feeding beans into the crushing and cooking device 131 and a water feeding assembly 137 for injecting water into the crushing and cooking device 131 (as shown in FIG. 1).

The bean feeding assembly 136 includes a bin 1361 and a bean feeding passage 1362 provided on and extended through the peripheral wall of the crushing and cooking device 131. One end of the bean feeding passage 1362 is communicated with the bin 1361, and the other end thereof is communicated with the crushing and cooking device 131. The bin 1361 is corresponded to the bean feeding passage 1362 and is mounted to the peripheral wall of the crushing and cooking device 131 via screws. The bean feeding passage 1362 is provided with a bean feeding controller 1363 for controlling the opening and closing of the bean feeding passage 1362. The bean feeding controller 1363 includes a driving portion 1364, a connecting rod 1365 and a baffle plate 1366. The baffle plate 1366 is rotatably mounted in the bean feeding passage 1362, and the connecting rod 1365 connects the driving portion 1364 with the baffle plate 1366.

The water feeding assembly 137 includes a water tank 1371, a water inlet tube 1373 and a water feeding passage provided on and extended through the peripheral wall of the crushing and cooking device 131. In the present embodiment, the water feeding passage and the bean feeding passage are integrated into one passage. One end of the water inlet tube 1373 is communicated with the water tank 1371, and the other end thereof is communicated with the water feeding passage. The water inlet tube 1373 is provided with a check valve 1374 to prevent water from flowing back to the water tank 1371. The bean feeding controller 1363 is electrically connected to the control unit 12. Further, a sealing assembly is provided on the inner surface of the peripheral wall of the crushing and cooking device 131 at a position corresponding to the bean feeding passage 1362 for sealing the bean feeding passage 1362. In the present embodiment, the sealing assembly is a soft rubber 1313, one end of which is connected to the inner surface of the peripheral wall of the crushing and cooking device 131. During the making of soybean milk, the soft rubber 1313 is adhered to the inner surface of the peripheral wall of the crushing and cooking device 131 under the impact of water flow, sealing the bean feeding passage 1362 to thereby preventing the material from entering the bean feeding passage 1362 during the making of soybean milk.

The discharging mechanism 133 includes a discharging passage 1331 and a discharging controller 1332 for controlling the discharging of the seriflux. The discharging passage 1331 is provided on and extended through the peripheral wall of the crushing and cooking device 131 corresponding to a boiling container 14. The discharging controller 1332 is a control valve including a valve body 1333, a valve core 1334, a connecting body 1335 and an operating portion 1336. The valve body 1333 is corresponded to the discharging passage 1331 and is fixedly connected to the peripheral wall of the crushing and cooking device 131. The valve core 1334 is rotatably mounted in the valve body 1333. The operating portion 1336 is mounted to the valve body 131 via a connecting seat 1337, and one end of the operating portion 1336 is connected to the valve core 1334 via the connecting body 1335 for driving the valve core 1334 to rotate, and the other end thereof is electrically connected to the control unit 12. It is to be understood that the valve body 1333 may be integrated with or detachably connected with the crushing and cooking device 14.

The crushing cutter 134 is mounted to the end of the shaft of the motor 135, and includes at least one blade which can pump the seriflux. In the present embodiment, the distance between the end of the blade of the crushing cutter 134 and the inner wall of the crushing and cooking device 131 within the rotation plane of the crushing cutter 134 is smaller than the radius of the crushing cutter 134. In this way, the material can be forced to pass through the interspace between the crushing cutter 134 and the crushing and cooking device 131 to thereby be better guided to the crushing cutter 134 for being crushed. Further, the motor has a rated speed of 6000-50000 r/min, which is sufficient to ensure the efficiency of heat produced by friction. The efficiency of heat produced by friction is low if the rated speed is too low. However, it is unsafe to the user if the rated speed is too high, besides it is also noisy if the rated speed is too high.

Further, the ratio of the diameter of the crushing cutter 134 to a diameter of a sphere having a volume equal to that of the crushing and cooking device 131 may be further defined to be 1:3 to 1:1, which not only can ensure a smooth circulation of the material but also can effectively define the material to be adjacent to the crushing cutter 134, and thus the crushing effect of the crushing cutter 134 is enhanced. It is difficult to mount the crushing cutter 134 in the crushing and cooking device 131 if the ratio of the radius of the crushing cutter 134 to the radius of the sphere having the volume equal to that of the crushing and cooking device 131 is larger than 1:1; and if the ratio of the radius of the crushing cutter 134 to the radius of the sphere having the volume equal to that of the crushing and cooking device 131 is smaller than 1:3, the material can not be well defined to be adjacent to the crushing cutter 134 by the crushing and cooking device 131 since the crushing and cooking device 131 is too large relative to the crushing cutter 134, therefore the efficiency of the crushing and cooking is reduced. In the present embodiment, it is desirable if the ratio of the radius of the crushing cutter 134 to the radius of the sphere having the volume equal to that of the crushing and cooking device 131 is 1:2.

Where assembling the soybean milk maker 10, firstly, the mounting portion 1311 of the crushing and cooking device 131 is fixedly connected to the top plate 112 of the base 11 via bolts; then the motor 135 is mounted to the mounting portion 1311; subsequently, the bin 1361 is mounted to the crushing and cooking device 131, and then the water tank 1371 is communicated with the water feeding passage via the water inlet tube 1373; finally, the discharging controller 1332 is mounted to the crushing and cooking device 131.

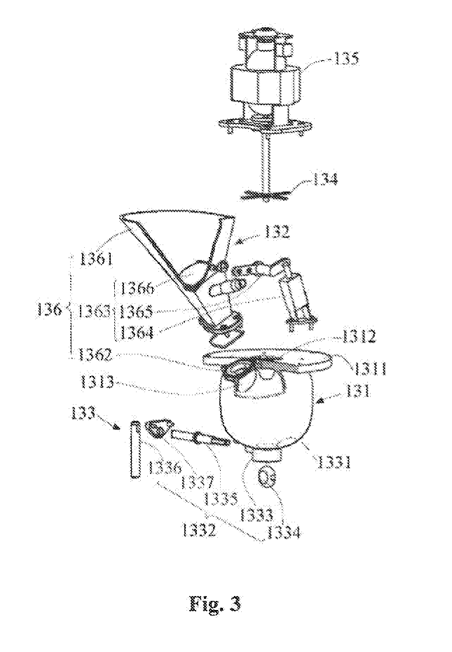

Reference is made to FIG. 3. Where making soybean milk with the soybean milk maker 10, firstly, the bean feeding controller 1363 is actuated by the control unit 12 such that beans for making soybean milk are all fed into the crushing and cooking device 131 through the bean feeding passage 1362. Then the water for making soybean milk is partly injected into the crushing and cooking device 131 through the water inlet tube 1373. Meanwhile, the motor 135 is actuated to drive the crushing cutter 134 to rotate in the crushing and cooking device 131 such that the material is crushed and is made into high concentration soybean milk. Since the soybean milk has a high concentration and the material is forced, by the crushing and cooking device 131, to be adjacent to the crushing cutter, friction forces among the high concentration soybean milk, the crushing cutter 134 and crushing and cooking device 131 are large, causing the temperature thereof being increased until the high concentration soybean milk is fully cooked. Then, the discharging passage 1331 is opened by the control unit 12 to discharge the cooked high concentration soybean milk into a container (such as a cup). Next, the remained part of the water for making soybean milk is injected into the crushing and cooking device 131 such that the residual soybean milk adhered to the inner surface of the peripheral wall of the crushing and cooking device 131 is blended with the water, thereby the mixture is discharged, through the discharging passage 1331, into the container and is blended with the soybean milk previously discharged into the container.

In the present embodiment, where making soybean milk, in a case that the ratio of the weight of the material to the weight of the water is 1:10 to 2:1, a high concentration seriflux or paste can be made after the material is mingled with the water in the crushing and cooking device 131 and is crushed by the crushing cutter 134, therefore the seriflux or paste, the crushing cutter 134 and the crushing and cooking device 131 can rub against one another more effectively such that the temperature can be increased by the frictions therebetween. If the ratio of the weight of the material to the weight of the water is smaller than 1:10, the concentration of the seriflux or paste made after the material is mingled with the water in the crushing and cooking device 131 and is crushed by the crushing cutter 134 is too low, therefore the friction forces among the seriflux or paste, the crushing cutter 134 and the crushing and cooking device 131 are small, and thus they can not rub effectively with one another to increase the temperature; if the ratio of the weigh of the material to the weight of the water is larger than 2:1, the concentration of the seriflux or paste made after the material is mingled with the water in the crushing and cooking device 131 and is crushed by the crushing cutter 134 is too high, the seriflux or paste may be condensed on the crushing cutter 134 or the crushing and cooking device 131, and the seriflux or paste can not be evenly heated. In the present embodiment, it is desirable if the ratio of the weight of the material to the weight of the water is 1:3. Moreover, the temperature can also be effectively increased by frictions among the seriflux or paste, the crushing cutter and the crushing and cooking device 131 if the ratio of the volume of the mixture of the material and the water to the volume of the crushing and cooking device 131 is ranged from 1:2 to 1:1. The material and the water will overflow the crushing and cooking device 131 if the ratio of the volume of the mixture of the material and the water to the volume of the crushing and cooking device 131 is larger than 1:1; and friction forces among the seriflux or paste, the crushing cutter 134 and the crushing and cooking device 131 will be reduced if the ratio of the volume of the mixture of the material and the water to the volume of the crushing and cooking device 131 is smaller than 1:2. In the present embodiment, it is desirable if the ratio of the volume of the mixture of the material and the water to the volume of the crushing and cooking device 131 is 1:1.5.

Where cleaning the soybean milk maker 10, firstly, water is injected into the crushing and cooking device 131; the motor 135 is actuated to drive the crushing cutter 134 to rotate, the crushing cutter 134 in turn drives the water to rotate in the crushing and cooking device 131, washing the shaft of the motor, the inner surface of the peripheral wall of the crushing and cooking device 131, the bean feeding passage 1362 and so on. In this way, the soybean milk maker is automatically cleaned.

The soybean milk maker 10 employs the crushing and cooking device 131 having the unique configuration, thus the time for making soybean milk is greatly reduced, the soybean milk maker 10 can finish the making of soybean milk within ten minutes, which soybean milk maker steps into an era of making soybean milk quickly, and solves the problem that a long period is spent by the prior soybean milk maker for making soybean milk, which problem has puzzled the industry for a long time.

During the period in which the material for making soybean milk is stirred by the crushing cutter 134 of the soybean milk maker 10 and is crushed to make soybean milk in the crushing and cooking device 131, the high concentration soybean milk is also cooked. In this way, the crushing of the material and the cooking of the material are performed simultaneously, thus the soybean milk is also cooked.

It can be understood that the inner surface of the crushing and cooking device may be further provided with ribs for interfering with the flow, to thereby facilitate rebounding of the material to the crushing cutter.

It can be understood that the high concentration soybean milk may also be blended with water in the crushing and cooking device, then soybean milk got by the blending process is discharged into the container; and the motor is rotated to stir the soybean milk during the blending process.

It can be understood that the process of blending the high concentration soybean milk with water may also be performed partly in the crushing and cooking device and partly in the container.

It can be understood that the sealing assembly may also have other valve type sealing structures.

It can be understood that the speed and the rotation direction of the motor may be switched where performing the crushing or the cleaning to increase the crushing effect or the cleaning effect.

### Second Embodiment

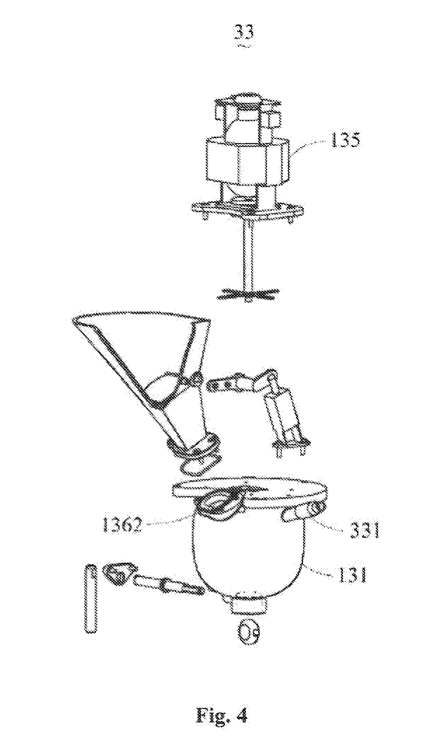

Reference is made to FIG. 4 which shows a second preferred embodiment of the feeding mechanism of the soybean milk maker according to the present application, which second preferred embodiment is different from the first preferred embodiment in that, the water feeding passage 331 and the bean feeding passage 1362 does not share one common passage but are separately provided on the peripheral wall of the crushing and cooking device 131. In this way, the control unit 12 can control the water feeding operation and the bean feeding operation respectively and more effectively.

### Third Embodiment

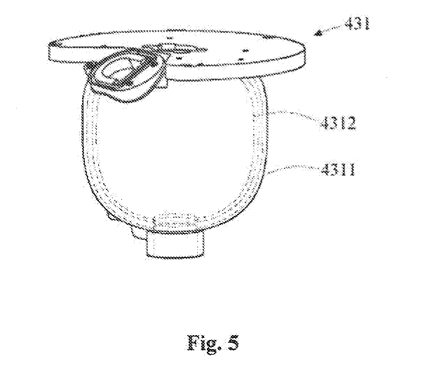

Reference is made to FIG. 5 which shows a third preferred embodiment of the crushing and cooking device of the soybean milk maker according to the present application. The crushing and cooking device 431 is different from the crushing and cooking device 131 in that, the crushing and cooking device 431 is provided with a thermal insulation layer, that is, the crushing and cooking device 431 includes a thermal insulation layer 4311 and an inner layer 4312. The inner layer 4312 is superposed to the thermal insulation layer 4311, forming a closed crushing chamber. Since the crushing and cooking device 431 is provided with a thermal insulation layer, noise generated during the crushing process can be effectively reduced, and the crushing chamber is isolated from the external environment, thereby influence of the external environment on the process of making soybean milk is reduced.

It can be understood that the crushing and cooking device may include a plurality of thermal insulation layers.

It can be understood that a vacuum layer may be provided between the inner layer and the thermal insulation layer to further isolate the crushing chamber from the external environment.

### Fourth Embodiment

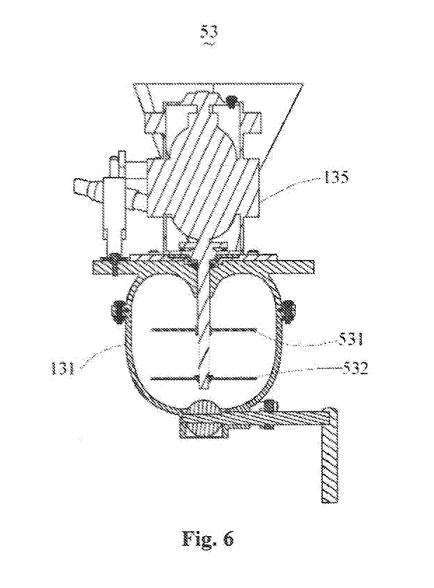

Reference is made to FIG. 6 which shows a fourth preferred embodiment of the feeding mechanism and other components of the soybean milk maker according to the present application, which fourth preferred embodiment is different from the first preferred embodiment in that, the present embodiment employs a double-layer cutter which includes an upper crushing cutter 531 and a lower crushing cutter 532. The upper crushing cutter 531 and the lower crushing cutter 532 are evenly arranged in the crushing and cooking device 131. The arrangement of the double-layer cutter not only can increase the crushing efficiency, but also can effectively drive water flow to the top portion of the crushing and cooking device 131 such that the root portion of the shaft of the motor 135 and the top portion of the crushing and cooking device 131 are washed during the cleaning process, realizing a thorough cleaning.

It can be understood that a multi-layer crushing cutter may also be employed.

### Fifth Embodiment

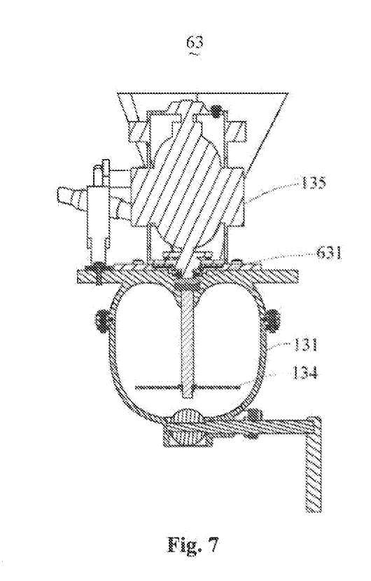

Reference is made to FIG. 7 which shows a fifth preferred embodiment of the feeding mechanism and other components of the soybean milk maker according to the present application, which fifth preferred embodiment is different from the first preferred embodiment in that, the crushing cutter 134 is mounted to the inner wall of the crushing and cooking device 131, and the motor 135 is located outside the crushing and cooking device 131. The motor 135 drives the crushing cutter 134 to rotate through a coupling 631, thereby the motor 135 can be conveniently disconnected from the crushing cutter 134.

It can be understood that the coupling may be a contact type coupling or a non-contact type coupling.

### Sixth Embodiment

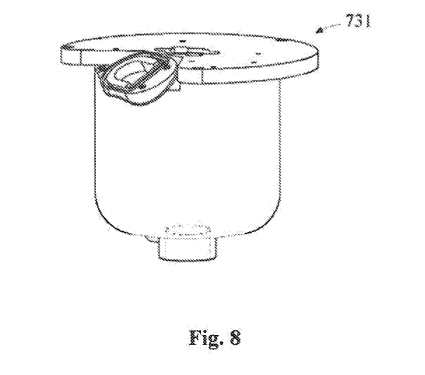

Reference is made to FIG. 8 which shows a sixth preferred embodiment of the crushing and cooking device of the soybean milk maker according to the present application. The crushing and cooking device 731 is different from the crushing and cooking device 131 in that, the crushing and cooking device 731 is hollow and has a rectangular shape. Since the crushing and cooking device 731 is hollow and has a rectangular shape, it is more convenient to mount elements such as the motor 152 on the outer peripheral wall of the crushing and cooking device 731.

It can be understood that the crushing and cooking device may also have other shapes as long as the material can be restricted around the crushing cutter by the crushing and cooking device, for example, the crushing and cooking device may be a hollow sphere, a hollow cylinder or a hollow ellipsoid.

### Seventh Embodiment

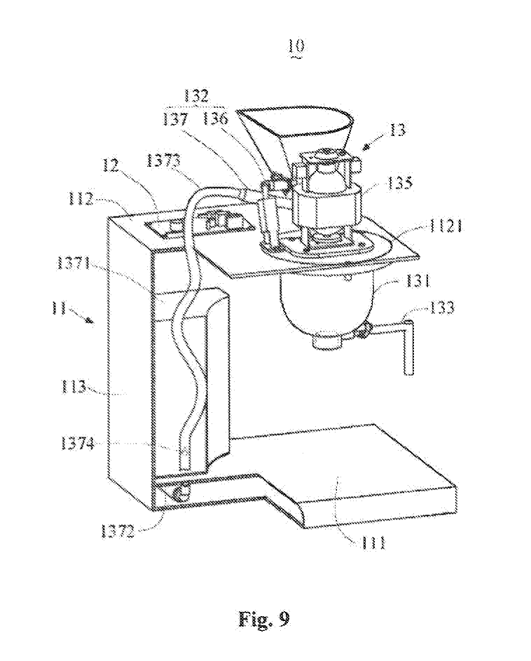

Reference is made to FIG. 9 which shows a seventh preferred embodiment of the crushing and cooking device of the soybean milk maker according to the present application. The soybean milk maker further includes a heating unit connected to the control unit. In the present embodiment, the heating unit is disposed upstream the crushing and cooking device 131. In particular, the heating unit is a heating film 1372 attached to the outer peripheral wall of the water inlet tube 1373, for heating water in the water inlet tube 1373 such that the water is boiled to rush upwards into the crushing and cooking device 131. That is, the heating unit not only can heat the water but also can control the injection of the water into the crushing and cooking device 131. In the present embodiment, water and/or the material are/is heated, by the heating unit, at least to 50 □, which facilitates shortening the time for the crushing and the cooking of the material and the water. Further, it is desirable if the water and/or the material are/is heated to 80□ to 100□ in the heating stage. It is difficult for the seriflux or paste to be rapidly heated, through frictions among the seriflux or paste, the crushing cutter 134 and the crushing and cooking device 131, and thus be cooked if the temperature of the water and/or the material after being heated is less than 50□; and the seriflux or paste will overflow the crushing and cooking device 131, or air pressure in the crushing and cooking device 131 becomes high if the temperature of the water and/or the material after being heated is more than 100□, which is dangerous.

It can be understood that the heating unit may be a heating tube provided adjacent to the water inlet tube. Apparently, the water tank 1371 may also be connected to the water inlet tube 1373 through a hydraulic pump (not shown in the figures) such that water is injected into the crushing and cooking device 131 through the hydraulic pump. In the present embodiment, the heating unit is disposed on the water tank 1371 to heat the water.

It can be understood that the heating unit may be disposed on the water tank or on the water feeding passage communicating the water tank with the crushing and cooking device; or the soybean milk maker may be further provided with an automatic feeding unit, the crushing and cooking device is provided with a feeding inlet, the automatic feeding unit is communicated with the feeding inlet of the crushing and cooking device, and the heating unit is disposed on the automatic feeding unit.

It can be understood that the heating unit may be disposed on the crushing and cooking device.

### Eighth Embodiment

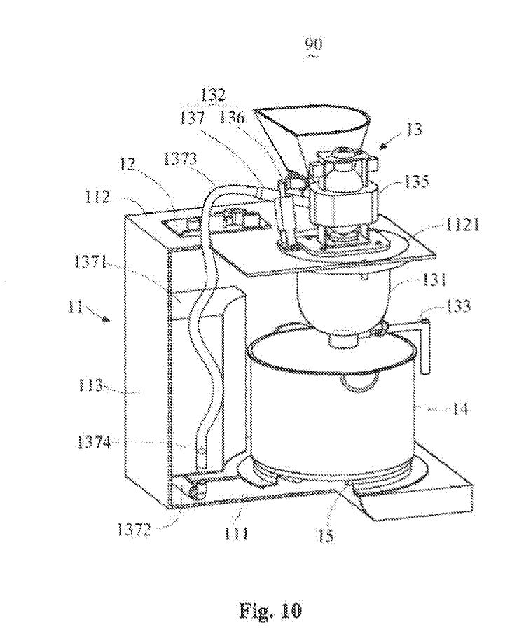

Reference is made to FIG. 10 which shows an eighth preferred embodiment of the soybean milk maker according to the present application, which eighth preferred embodiment is different from the seventh preferred embodiment in that, the soybean milk maker 90 further includes a boiling container 14 and a heating unit. In the present embodiment, the heating unit is an electrothermal tube 15 provided at the bottom portion of the boiling container 14. The boiling container 14 is removably placed on the pedestal 111 of the base 11 and is located downstream the crushing and cooking device 131, for receiving soybean milk flowing out of the crushing and cooking device 131. The electrothermal tube 15 is provided on the boiling container 14 and is electrically connected to the control unit 12. In the present embodiment, the crushing and cooking device has a volume of 500 milliliters.

In the soybean milk maker 90, cooked soybean milk in the crushing and cooking device 131 can be further cooked by the boiling container 14 and the heating unit.

It can be understood that the heating unit 15 may be an electromagnetic heating unit, a steam heating unit, a lightwave heating unit or the like.

It can be understood that the boiling container 14 may be omitted, while the heating unit 15 is directly provided on the crushing and cooking device 131 for assisting the cooking of soybean milk.

It can be understood that the heating unit may be provided on a receiving device; or the soybean milk maker further includes a receiving device and a discharging passage corresponding to the receiving device, the crushing and cooking device is provided with a discharging outlet, the discharging passage is communicated with the discharging outlet of the crushing and cooking device, and the heating unit is provided on the discharging passage.

### Ninth Embodiment

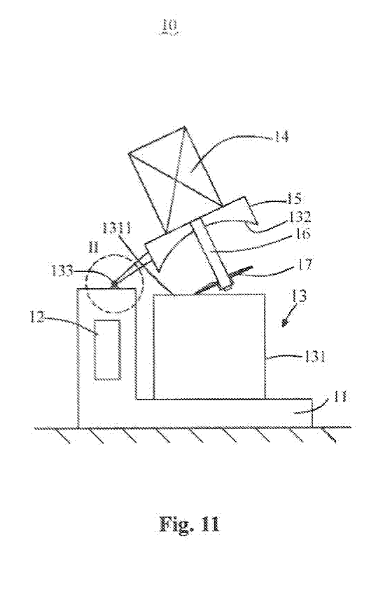

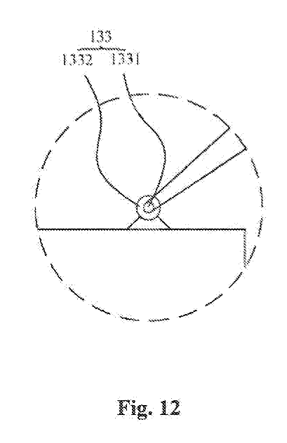

Reference is made to FIGS. 11 and 12 which show a ninth preferred embodiment of the rapid soybean milk making soybean milk maker according to the present application. The rapid soybean milk making soybean milk maker includes a base 11, a control unit 12, a crushing and cooking device 13, a motor base 15 in which a motor 14 is provided, a cutter shaft 16 and a crushing cutter 17. The motor 14 is electrically connected to the control unit 12. The cutter shaft 16 is extended into the crushing and cooking device 13. The crushing cutter 17 is provided at the end of the cutter shaft 16. The motor 14 drives the cutter shaft 16 to further drive the crushing cutter 17 to rotate. While the material is mingled with water in the crushing and cooking device 13 and is crushed by the crushing cutter 17 into seriflux or paste, the seriflux or paste is heated and cooked by heat generated by friction of the seriflux or paste itself, friction between the seriflux or paste and the crushing cutter 17, and friction between the seriflux or paste and the crushing and cooking device 13. The motor base 15 is arranged above the crushing and cooking device 13. In the present embodiment, the crushing and cooking device has a volume of 1000 milliliters.

Reference is also made to FIG. 12. The crushing and cooking device 13 includes: a crushing and cooking device 131 provided with an opening 1311, and a cover body 132 which can open and close the opening 1311 of the crushing and cooking device. In the present embodiment, the cover body 132 is provided at the bottom portion of the motor base 15 and is integrated with the motor base. The cutter shaft 16 is the shaft of the motor 14. The opening 1311 is provided at the top portion of the crushing and cooking device 131. The crushing and cooking device 131 is a hollow ellipsoid or a hollow cylinder. The cover body 132 is provided with a hole 1321 through which the shaft of the motor is extended into the crushing and cooking device 131. The crushing and cooking device 131 is removably placed on the base 11, in this way, the user can take the crushing and cooking device 131 to the material house to add material without the need of another container for receiving the material, which is convenient to use. Moreover, the user can also remove the crushing and cooking device 131 from the base 11 to wash the same under a water faucet, therefore the cleaning is convenient and flexible. One end of the cover body 132 is removably connected to the base 11 through a hinge structure 133. The hinge structure 133 includes a shaft body 1331 fixedly connected with the motor base 15 and a shaft barrel 1332 fixedly connected with the base 11. The shaft body 1331 is embedded in the shaft barrel 1332.

Where making soybean milk with the soybean milk maker 10, firstly, the cover body 132 is opened, then, the material may be easily put into the crushing and cooking device 131. Then the cover body 132 is closed to close the opening 1311. At this time, the power source is switched on, and the motor 14 is controlled by the control unit 12 to perform the making of the soybean milk.

Where cleaning the soybean milk maker 10, the crushing cutter 17 is driven by the motor 14 to rotate, the crushing cutter 17 stirs water to rotate in the crushing cutter 17, washing the cutter shaft 16 and the inner peripheral wall of the crushing and cooking device 13, thereby realizing an automatic cleaning of the soybean milk maker 10. Apparently, the soybean milk maker may also be cleaned manually. That is, the cleaning may be performed by the user manually after the cover body 132 is opened. Therefore, many choices are provided in use and it is more convenient. The feeding mechanism and/or the water feeding mechanism may be eliminated from the soybean milk maker 10 that can make soybean milk quickly, thereby the configuration of the soybean milk maker is more compact and it is applicable to be used in household, besides the cost of the whole maker is also reduced. Moreover, the crushing and cooking device 131 has a certain volume, where adding the material manually, the problem of bad crushing and cooking due to adding too much material can be effectively solved, which has a “Fool-Proof” effect and can ensure the quality of soybean milk. Further, the user can also open the cover body 132 anytime anywhere to replace the crushing cutter 17 according to various materials to be crushed and cooked.

It can be understood that the speed and the rotation direction of the motor may be switched where performing the crushing or the cleaning to increase the crushing effect or the cleaning effect.

It can be understood that the rapid soybean milk making soybean milk maker 10 not only can be used to make soybean milk, but also can be used to make other food that needs to be crushed and heated such as fruit and vegetable juice, sesame paste or the like.

It can be understood that, in the rapid soybean milk making soybean milk maker 10, heat generated by frictions includes not only heat generated by friction of the seriflux or paste itself, friction between the seriflux or paste and the crushing cutter 17, and friction between the seriflux or paste and the crushing and cooking device 13, heat generated by frictions among elements in the crushing and cooking device 13 can also be used to heat the seriflux or paste, which should also fall within the protection scope of the present application.

### Tenth Embodiment

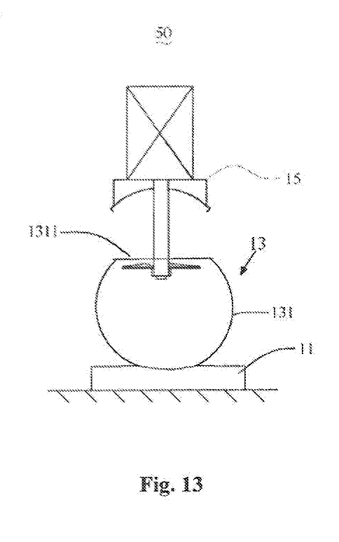

Reference is made to FIG. 13 which shows a tenth preferred embodiment of the soybean milk maker according to the present application. The soybean milk maker 50 is different from that of the ninth embodiment in that, the crushing and cooking device 131 is fixedly mounted on the base 11 or is integrated with the base 11, and the motor base 15 is mounted at the opening 1311 of the crushing and cooking device 131 through a buckle structure 151. In the present embodiment, the crushing and cooking device has a volume of 100 milliliters.

It can be understood that the motor base 15 is directly snap fit at the opening 1311 of the crushing and cooking device 131.

### Eleventh Embodiment

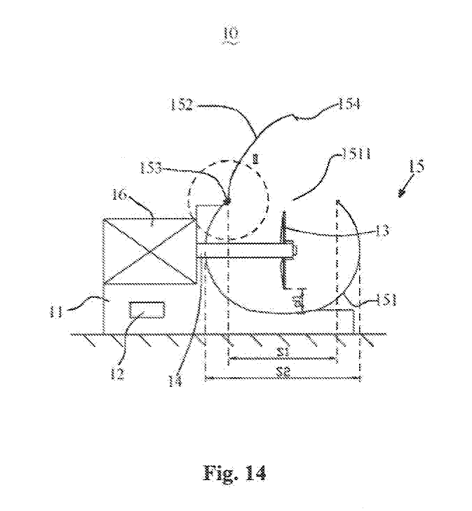

Reference is made to FIG. 14 which shows an eleventh preferred embodiment of the soybean milk maker according to the present application. The soybean milk maker 10 includes a base 11, a control unit 12, a crushing cutter 13, a cutter shaft 14, a crushing and cooking device 15 and a motor 16. The motor 16 drives the crushing cutter 13 to rotate, and the motor 16 is electrically connected to the control unit 12. The cutter shaft 14 is extended in the crushing and cooking device 15. The crushing cutter 13 is provided at the end of the cutter shaft 14. While the material is mingled with water in the crushing and cooking device 15 and is crushed by the crushing cutter 13 into seriflux or paste, the seriflux or paste is heated and cooked by heat generated by friction of the seriflux or paste itself, friction between the seriflux or paste and the crushing cutter 13, and friction between the seriflux or paste and the crushing and cooking device 15. In the present embodiment, the crushing and cooking device has a volume of 800 milliliters.

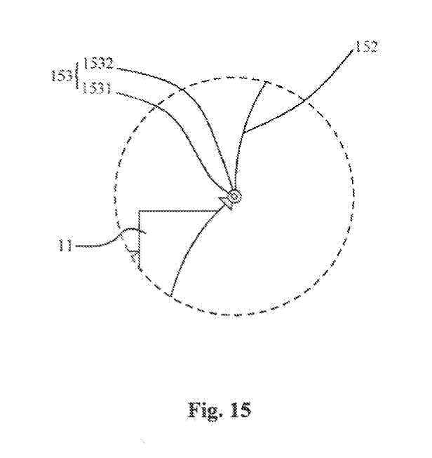

Reference is also made to FIG. 15. The crushing and cooking device 15 includes: a crushing and cooking device 151 provided with an opening 1511, and a cover body 152 which can open and close the opening 1511 of the crushing age. The crushing and cooking device 151 is fixedly mounted on the base 11. One end of the cover body 152 is mounted to one side of the opening 1511 through a hinge structure 153, and the other end of the cover body 152 can be locked to the other side of the opening 1511 through a snap 154. The hinge structure 153 includes a shaft body 1531 fixedly connected on the cover body 152 and a shaft barrel 1532 fixedly connected to the crushing and cooking device 151. The shaft body 1531 is embedded in the shaft barrel 1532. In the present embodiment, the opening 1511 is provided at the top portion of the crushing and cooking device 151, and the crushing and cooking device 151 is a hollow ellipsoid or a hollow cylinder.

It is to be noted that it is preferable that the ratio of the area S₁ of the opening 1511 to the area S₂ of the maximum cross-sectional area of the crushing and cooking device 151 is between 1:4 and 1:1, such that it is suitable for adding material manually. If the ratio of the area S₁ of the opening 1511 to the area S₂ of the maximum cross-sectional area of the crushing and cooking device 151 is smaller than 1:4, the opening 1511 is too small and it is difficult to add the material into the crushing and cooking device 151 within a short time. It is well known that the maximum of the area S₁ of the opening 1511 is the area S₂ of the maximum cross-sectional area of the crushing and cooking device 151. In the present embodiment, the ratio of the area of the opening 1511 to the area S₂ of the maximum cross-sectional area of the crushing and cooking device 151 is 3:4.

The motor 16 is horizontally provided on the base 11 and is located at a side of the crushing and cooking device 151. In the present embodiment, the cutter shaft 14 is the shaft of the motor 16, which passes through the wall of the crushing and cooking device 151 and extends into the crushing and cooking device 151. The minimum distance d₁ between the crushing cutter 13 and the bottom of the crushing and cooking device 151 is 1-30 millimeters, therefore the crushing cutter 15 can be embedded in the material, which increases the probability that the crushing cutter 15 is in collision with the material. If the minimum distance d₁ between the crushing cutter 15 and the bottom of the crushing and cooking device 151 is smaller than 1 millimeter, the material may be stuck between the crushing cutter 15 and the crushing and cooking device 151, which increases the difficulty of the cleaning. If the minimum distance d₁ between the crushing cutter 15 and the crushing and cooking device 151 is larger than 30 millimeters, it is difficult to stir the material at the bottom of the crushing and cooking device 151, and there may occur that the crushing cutter can not catch the material at the bottom at all, which will waste more electrical energy. In the present embodiment, the minimum distance d₁ between the crushing cutter 15 and the bottom of the crushing and cooking device 151 is 10 millimeters.

Where the soybean milk maker 10 is used to make soybean milk, firstly, the cover body 152 is opened, at this time, the material can be easily put into the crushing and cooking device 151; then the cover body 152 is closed to close the opening 1511, at this time, power source may be switched on such that the motor 16 is controlled by the control unit 12 to perform the making of the soybean milk.

Where cleaning the soybean milk maker 10, the crushing cutter 15 is driven by the motor 16 to rotate, the crushing cutter 15 stirs water to rotate in the crushing and cooking device 15, washing the cutter shaft 14 and the inner peripheral wall of the crushing and cooking device 15, thereby realizing an automatic cleaning of the soybean milk maker 10. Of course, the soybean milk maker may also be cleaned manually. That is, the cleaning may be performed by the user manually after the cover body 152 is opened. Therefore, many choices are provided in use and it is more convenient.

In the soybean milk maker 10 according to the present application, the crushing and cooking device 15 that can be opened and closed is employed. Therefore the user can open the cover body 152 of the crushing and cooking device 15 to add the material into the crushing and cooking device 151 where using the soybean milk maker 10. In this way, the feeding mechanism and/or the water feeding mechanism may be eliminated from the soybean milk maker 10, therefore the structure of the soybean milk maker is more compact and it is applicable to be used in household, besides the cost of the whole maker is also reduced. Moreover, the crushing and cooking device 151 has a certain volume, where being added with the material manually, the problem of bad crushing and cooking due to adding too much material can be effectively avoided, which has a “Fool-Proof” effect and can ensure the quality of soybean milk. Further, the user can also open the cover body 152 anytime anywhere to replace the crushing cutter 15 according to various materials to be crushed and cooked.

The motor 16 of the soybean milk maker 10 according to the present application is horizontally provided on the base 11 and is located at a side of the crushing and cooking device 151, the center of gravity of the whole soybean milk maker is lowered, the stability of the whole maker is improved, and the probability that the seriflux or water enters the motor 16 and the control unit 12 during a manual operation is reduced, thus the making of the soybean milk is more safe and reliable. Further, the crushing cutter 13 is brought into direct contact with the material and is driven by the motor 16 to rotate at a high speed to thereby crush the material. Thereby the crushing efficiency is improved.

In the soybean milk maker 10 according to the present application, the crushing and cooking device 15 that can be opened and closed is employed. Therefore the user can open the cover body 152 of the crushing and cooking device 15 to add the material into the crushing and cooking device 152. In this way, the feeding mechanism and/or the water feeding mechanism may be eliminated from the soybean milk maker 10, therefore the structure of the soybean milk maker is more compact and it is applicable to be used in household, besides the cost of the whole maker is also reduced. Moreover, the crushing and cooking device 151 has a certain volume, where being added with the material manually, the problem of bad crushing and cooking due to adding too much material can be effectively avoided, which has a “Fool-Proof” effect and can ensure the quality of soybean milk. Further, the user can also open the cover body 152 anytime anywhere to replace the crushing cutter 13 according to various materials to be crushed and cooked.

It can be understood that the speed and rotation direction of the motor may be switched where performing the crushing or the washing to increase the crushing effect or the cleaning effect.

It can be understood that the rapid soybean milk making soybean milk maker 10 not only can be used to make soybean milk, but also can be used to make other food that needs to be crushed and heated such as fruit and vegetable juice, sesame paste or the like.

It can be understood that, in the present soybean milk maker, heat generated by frictions includes not only heat generated by friction of the seriflux or paste itself, friction between the seriflux or paste and the crushing cutter 13, and friction between the seriflux or paste and the crushing and cooking device 15, heat generated by frictions among elements in the crushing and cooking device 13 can also be used to heat the seriflux or paste, which should also fall within the protection scope of the present application

What is claimed is:

1. A rapid soybean milk making soybean milk maker comprising
a base and a control unit;
a crushing cutter;
a motor driving the crushing cutter;
a heating unit electrically connected to the control unit; and
a crushing and cooking device; and, wherein
the motor and the crushing and cooking device are provided on the base,
the motor is electrically connected to the control unit,
the crushing cutter is located in the crushing and cooking device, and the heating unit is configured to preheat water, such that when a material is mingled with the preheated water in the crushing and cooking device and is crushed by the crushing cutter into seriflux or mud or paste, heat is generated by frictions between the seriflux or mud or paste and the crushing cutter, and between the seriflux or mud or paste and the crushing and cooking device, wherein the generated heat further increases the temperature of the seriflux, mud or paste to a second temperature, by which the soybean milk is prepared,
the crushing and cooking device has a volume of 50-1000 milliliters, and a diameter of a sphere having a volume equal to that of the crushing and cooking device is D, a diameter of a rotation plane of the crushing cutter is d, a ratio of D to d is α, and 1<α≦3.

2. The rapid soybean milk making soybean milk maker according to claim 1, wherein the first temperature ranges from 80 to 100 degrees Celsius.

3. The rapid soybean milk making soybean milk maker according to claim 1, wherein the crushing and cooking device has a volume of 100-500 milliliters.

4. The rapid soybean milk making soybean milk maker according to claim 1, wherein the crushing and cooking device is a closed container or a substantially closed container.

5. The rapid soybean milk making soybean milk maker according to claim 1, wherein the crushing and cooking device is a hollow sphere, a hollow cylinder or a hollow ellipsoid.

6. The rapid soybean milk making soybean milk maker according to claim 1, wherein the crushing and cooking device is provided with a feeding inlet and a discharging outlet.

7. The rapid soybean milk making soybean milk maker according to claim 1, wherein the heating unit is provided on the crushing and cooking device.

8. The rapid soybean milk making soybean milk maker according to claim 1, wherein the heating unit is provided upstream the crushing and cooking device.

9. The rapid soybean milk making soybean milk maker according to claim 8, wherein the soybean milk maker further comprises a water tank communicated with the crushing and cooking device, the heating unit is provided on the water tank or on a water feeding passage communicating the water tank with the crushing and cooking device; or the soybean milk maker is further provided with an automatic feeding unit, the crushing and cooking device is provided with a feeding inlet, the automatic feeding unit is communicated with the feeding inlet of the crushing and cooking device, and the heating unit is provided on the automatic feeding unit.

10. The rapid soybean milk making soybean milk maker according to claim 1, wherein a ratio of a volume of the material and the water after being mingled to a volume of the crushing and cooking device is 1:2 to 1:1.

11. The rapid soybean milk making soybean milk maker according to claim 1, wherein the crushing and cooking device is provided with an opening on which a cover body is removably provided.

12. The rapid soybean milk making soybean milk maker according to claim 1, wherein the motor is horizontally provided in the base and is located at a side of the crushing and cooking device, and a shaft of the motor passes through a side wall of the crushing and cooking device and extends into the crushing and cooking device; or the motor is provided in the base and is located above the crushing and cooking device, the motor drives the crushing cutter to rotate through a driving shaft which passes through a hole in a top wall of the crushing and cooking device and extends downwards into the crushing and cooking device; or the motor is provided in the base and is located below the crushing and cooking device, the motor drives the crushing cutter to rotate through a driving shaft which passes through a hole in a bottom wall of the crushing and cooking device and extends upwards into the crushing and cooking device.

13. The rapid soybean milk making soybean milk maker according to claim 1, wherein the heat generated by frictions between the seriflux or mud or paste and the crushing cutter, and between the seriflux or mud or paste and the crushing and cooking device cooks the seriflux, mud or paste from the uncooked temperature to the cooked temperature in less than 5 minutes.

14. The rapid soybean milk making soybean milk maker according to claim 1, wherein the motor has a rated speed that is in the range of 6000 to 50000 rpm.

15. A rapid soybean milk making method, applied to a soybean milk maker, the soybean milk maker comprising a base and a control unit; a crushing cutter; a motor driving the crushing cutter; a heating unit electrically connected to the control unit; and a crushing and cooking device; and wherein the motor and the crushing and cooking device are provided on the base, the motor is electrically connected to the control unit, the crushing cutter is located in the crushing and cooking device; and the crushing and cooking device has a volume of 50-1000 milliliters, and a diameter of a sphere having a volume equal to that of the crushing and cooking device is D, a diameter of a rotation plane of the crushing cutter is d, a ratio of D to d is α, and 1<α≦3; and
wherein the method comprises:
preheating, by the heating unit, water to a first temperature;
mingling the material with the preheated water in the crushing and cooking device;
crushing, by the crushing cutter, the material into seriflux or mud or paste;
and increasing, by heat generated by frictions between the seriflux or mud or paste and the crushing cutter and between the seriflux or mud or paste and the crushing and cooking device, the temperature of the seriflux, mud or paste to a second temperature, by which the soybean milk is prepared.

16. The rapid soybean milk making method according to claim 14, wherein the first temperature ranges from 80 to 100 degrees Celsius.

17. The rapid soybean milk making method according to claim 14, wherein in the process of mingling the material with the preheated water in the crushing and cooking device, a ratio of a weight of the material to a weight of the preheated water is 1:10 to 2:1.

18. The rapid soybean milk making method according to claim 14, wherein in the process of mingling the material with the preheated water in the crushing and cooking device, a ratio of a volume of the material and the preheated water after being mingled to a volume of the crushing and cooking device is 1:2 to 1:1.

19. The rapid soybean milk making method according to claim 14, wherein the motor has a rated speed that is in the range of 6000 to 50000 rpm.
